(19) United States
(12) Patent Application Publication
(10) Pub. No.: US 2026/0274061 A1
(43) Pub. Date: Sep. 17, 2026

(54) HYBRID DRIVE DEVICE

(71) Applicant: AISIN CORPORATION, Kariya, Aichi (JP)

(72) Inventors: Rikiya KUBO, Kariya-shi (JP); Sou OKITA, Kariya-shi (JP); Katsunori MIYOSHI, Kariya-shi (JP); Masayoshi HORICHI, Kariya-shi (JP); Akihiro KAWAMURA, Kariya-shi (JP); Ryosuke KOSAKA, Kariya-shi (JP); Rio NAGASE, Kariya-shi (JP)

(73) Assignee: AISIN CORPORATION, Kariya, Aichi (JP)

(21) Appl. No.: 19/471,949

(22) PCT Filed: May 24, 2024
(86) PCT No.: PCT/JP2024/019149

§ 371 Date: Oct. 2, 2025

(30) Foreign Application Priority Data
May 31, 2023 (JP) 2023-090528

(51) Int. Cl. B60K 6/445; B60K 6/38; B60K 6/40

(52) U.S. Cl. CPC B60K 6/445; B60K 6/38; B60K 6/40; B60K 2006/381

(57) ABSTRACT

A hybrid drive device includes: a first rotary electric machine disposed on a first axis; an input member; a second rotary electric machine; an output member that is drivingly connected to the second rotary electric machine and outputs rotation; a power distribution planetary gear mechanism including a first rotary element drivingly connected to the first rotary electric machine, a second rotary element drivingly connected to the input member, and a third rotary element drivingly connected to the output member; a brake unit; and a clutch unit interposed between the third rotary element and the output member and configured to disconnect the third rotary element and the output member. The clutch unit is disposed on the first axis and disposed on an outer circumferential side of the planetary gear mechanism to overlap the planetary gear mechanism in a first radial view along a first radial direction.

### TECHNICAL FIELD

The present disclosure relates to a hybrid drive device mounted on a vehicle etc.

### BACKGROUND ART

There is a split hybrid drive device mounted on a vehicle etc. The hybrid drive device includes an input shaft drivingly connected to an engine, namely an internal combustion engine, a first rotary electric machine (hereinafter referred to as “first motor”), an output shaft drivingly connected to a wheel, a second rotary electric machine (hereinafter referred to as “second motor”) drivingly connected to the output shaft, and a power distribution planetary gear mechanism including three rotary elements drivingly connected to these components. The hybrid drive device can regenerate part of the driving force of the engine using the first motor, and add the driving force of the second motor to the remaining driving force of the engine to output the resultant force.

As such a split hybrid drive device, there is also proposed a hybrid drive device in which a disconnection clutch that can disconnect a driving force is provided between an output rotary element (e.g., a ring gear) of the planetary gear mechanism and each of the output shaft and the second motor and a brake that can lock the rotation of the output rotary element is provided such that electric power can be generated by the first motor using the driving force of the engine and the vehicle can travel using the second motor, that is, the split system and the series system can be switched (see Patent Documents 1 and 2).

### RELATED ART DOCUMENTS

### Patent Documents

Patent Document 1: Japanese Unexamined Patent Application Publication No. 11-313407 (JP 11-313407 A)

Patent Document 2: WO 2022/233355

### SUMMARY OF THE DISCLOSURE

### Problem to be Solved by the Disclosure

In the device of Patent Document 1 that includes the first motor and the second motor disposed on parallel axes (see FIGS. 1 and 2 of Patent Document 1) and is particularly suitable for an FF type (front engine, front drive) vehicle in which an engine output shaft is disposed transversely relative to the vehicle traveling direction, the above disconnection clutch is disposed coaxially with the second motor. The second motor that outputs the driving force is larger in size than the first motor that mainly generates electric power. Therefore, when the disconnection clutch and the second motor are arranged coaxially, the axial size increases, causing a problem of influence on the vehicle width and the maximum steering angle (minimum turning radius) of wheels particularly in the vehicle in which the engine output shaft is disposed transversely.

In the device of Patent Document 2, the disconnection clutch and the brake are disposed coaxially with the first motor between the power distribution planetary gear mechanism and an output gear for transmitting the rotation of the planetary gear mechanism to a counter shaft. When the first motor, the power distribution planetary gear mechanism, the disconnection clutch, the brake, and the output gear are arranged coaxially, there is similarly a problem that the axial size increases.

An object of the present disclosure is to provide a hybrid drive device that is switchable between a split system and a series system while suppressing an increase in axial size.

### Means for Solving the Problem

One aspect of the present disclosure is a hybrid drive device including: a first rotary electric machine disposed on a first axis; an input member disposed on the first axis and drivingly connected to an engine; a second rotary electric machine disposed on a second axis different from the first axis; an output member that is drivingly connected to the second rotary electric machine and outputs rotation; a power distribution planetary gear mechanism including a first rotary element drivingly connected to the first rotary electric machine, a second rotary element drivingly connected to the input member, and a third rotary element drivingly connected to the output member, the planetary gear mechanism being disposed on the first axis; a brake unit that locks rotation of the third rotary element relative to a case; and a clutch unit interposed between the third rotary element and the output member and configured to disconnect the third rotary element and the output member. When a direction orthogonal to the first axis is a first radial direction, the clutch unit is disposed on the first axis and disposed on an outer circumferential side of the planetary gear mechanism to overlap the planetary gear mechanism in a first radial view along the first radial direction.

### Effects of the Disclosure

According to the present disclosure, it is possible to switch the split system and the series system while suppressing an increase in axial size.

### BRIEF DESCRIPTION OF THE DRAWINGS

FIG. 1 is a skeleton diagram showing a schematic configuration of a hybrid drive device according to a first embodiment.

FIG. 2 is a sectional view showing the overall hybrid drive device according to the first embodiment.

FIG. 3 is an enlarged sectional view showing a planetary gear mechanism, a clutch, and a brake of the hybrid drive device according to the first embodiment.

FIG. 4 is an enlarged sectional view showing a planetary gear mechanism, a clutch, and a brake of a hybrid drive device according to a second embodiment.

### MODES FOR CARRYING OUT THE DISCLOSURE

### First Embodiment

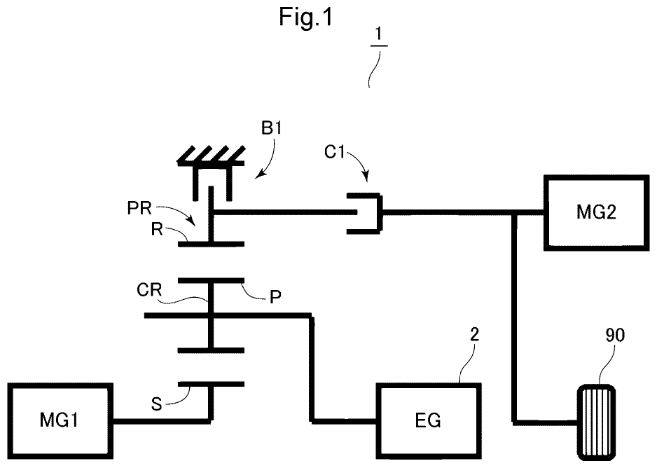

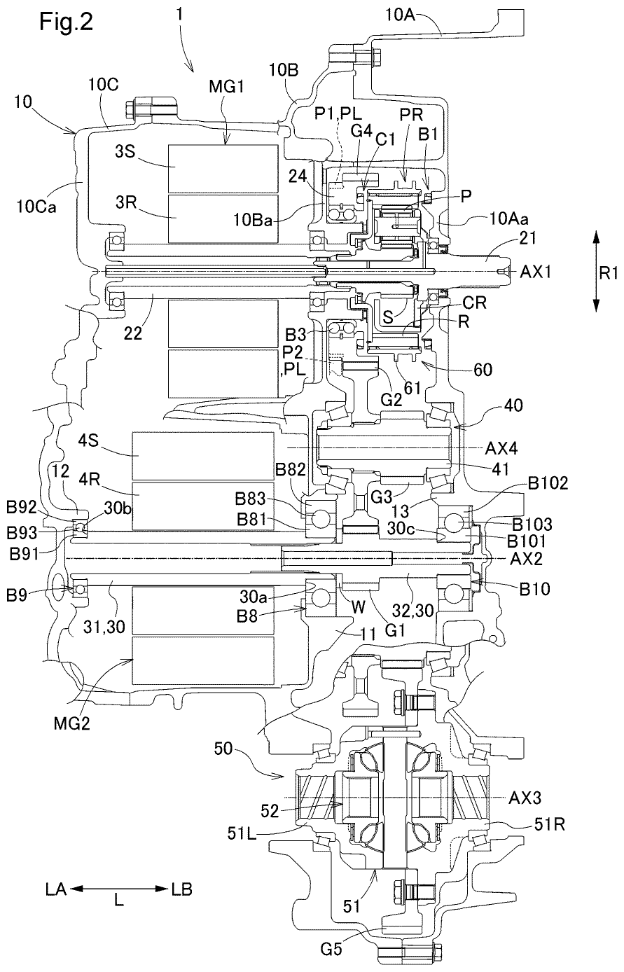

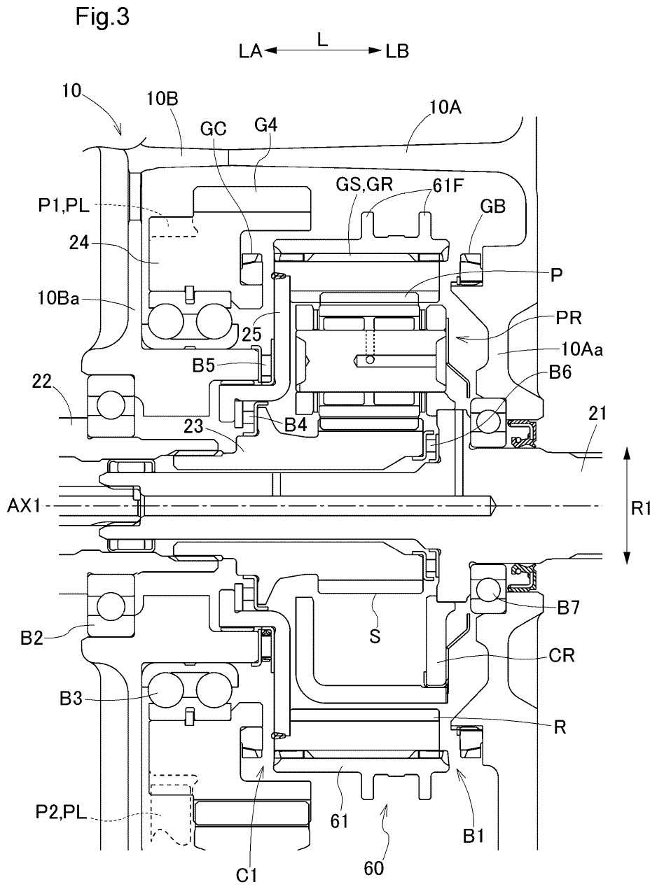

A hybrid drive device according to a first embodiment of the present disclosure will be described below with reference to FIGS. 1 to 3. FIG. 1 is a skeleton diagram showing a schematic configuration of the hybrid drive device according to the first embodiment. FIG. 2 is a sectional view showing the entire hybrid drive device according to the first embodiment. FIG. 3 is an enlarged sectional view showing a planetary gear mechanism, a clutch, and a brake of the hybrid drive device according to the first embodiment.

### [Schematic Configuration of Hybrid Drive Device]

First, a schematic configuration of a hybrid drive device 1 according to the first embodiment will be described with reference to FIG. 1. The hybrid drive device 1 is suitable for use in, for example, an FF (front engine, front drive) type vehicle in which an output shaft of an engine 2 is disposed transversely relative to the traveling direction, and is used in a hybrid vehicle that is switchable between a so-called split system and a so-called series system.

The hybrid drive device 1 includes a first motor generator (hereinafter referred to as “first motor”) MG1 as a first rotary electric machine, a second motor generator (hereinafter referred to as “second motor”) MG2 as a second rotary electric machine, a power distribution planetary gear mechanism PR, a disconnection clutch C1 as a clutch unit or an intermesh clutch, and a brake B1 as a brake unit or an intermesh brake. The hybrid drive device 1 is drivingly connected to the engine 2 as a driving source of the internal combustion engine on the input side, and is drivingly connected to wheels 90 on the output side.

The planetary gear mechanism PR is a so-called single-pinion planetary gear mechanism including a sun gear S as a first rotary element, a ring gear R as a third rotary element, and a carrier CR as a second rotary element that rotatably supports pinion gears P that mesh with the sun gear S and the ring gear R. The engine 2 is drivingly connected to the carrier CR, and the first motor MG1 is drivingly connected to the sun gear S. The second motor MG2 is drivingly connected to the ring gear R via the disconnection clutch C1, and the second motor MG2 is drivingly connected to the wheels 90. The ring gear R is structured such that its rotation can be stopped by the brake B1.

### [Operation of Hybrid Drive Device]

Next, the operation of the hybrid drive device 1 according to the first embodiment will be described with reference to FIG. 1. The hybrid drive device 1 is switchable between a split hybrid drive mode (hereinafter referred to as “split mode”) and a series hybrid drive mode (hereinafter referred to as “series mode”).

First, when a control unit (ECU) (not shown) determines to execute the split mode, the control unit controls the disconnection clutch C1 to be engaged and the brake B1 to be released. Thus, the ring gear R of the planetary gear mechanism PR, the second motor MG2, and the wheels 90 are drivingly connected via the counter shaft 41 (see FIG. 2) serving as an output member.

In the split mode, during hybrid traveling in which the engine 2 is started, the driving rotation of the engine 2 is input from an input shaft 21 (see FIG. 2) serving as an input member to the carrier CR of the planetary gear mechanism PR. Part of the driving rotation input to the carrier CR is transmitted to the first motor MG1 via the sun gear S, and is regenerated by the first motor MG1 to charge a battery (not shown) (or electric power is directly supplied to the second motor MG2). Regenerative torque is applied to the sun gear S due to the regeneration by the first motor MG1. Therefore, the remainder of the driving rotation input to the carrier CR is transmitted from the ring gear R to the wheels 90 via the counter shaft 41. That is, the driving force of the engine 2 is distributed to the first motor MG1 and the counter shaft 41 (wheels 90) by the planetary gear mechanism PR. In this state, the second motor MG2 outputs assist torque as needed based on a requested driving force such as an accelerator operation amount, and the driving force is transmitted to the counter shaft 41 and output to the wheels 90.

When driving EV traveling is determined in the split mode, the driving rotation of the second motor MG2 is output to the wheels 90 via the counter shaft 41. At this time, when the disconnection clutch C1 is engaged, the ring gear R is rotated by the driving rotation of the second motor MG2, but the sun gear S and the first motor MG1 idle because the engine 2 is stopped and the carrier CR is stopped. When non-driving EV traveling is determined, the driving force is transmitted from the wheels 90 in the opposite direction to that during driving, and the driving force is regenerated by the second motor MG2.

For example, when EV traveling is performed in the split mode for a short period, EV traveling using the second motor MG2 is possible by idling the sun gear S and the first motor MG1. However, continuation of this state is not good in terms of fuel efficiency (electric efficiency) of the vehicle. Therefore, the control unit (not shown) determines whether to switch to the series mode depending on, for example, the state of the vehicle and the traveling condition. Thus, the control unit controls the disconnection clutch C1 to be released and the brake B1 to be engaged. The state of the vehicle may be the remaining charge level of the battery, a water temperature, etc. The traveling condition may be a condition in which the requested driving force is large and the total output of the driving force of the engine 2 and the driving force of the second motor MG2 is required.

In the series mode, during driving EV traveling, the driving rotation of the second motor MG2 is output to the wheels 90 and, during non-driving EV traveling, the driving force caused by the rotation of the wheels 90 is regenerated by the second motor MG2. For example, when the remaining charge level of the battery decreases, the engine 2 is started. Then, the carrier CR of the planetary gear mechanism PR is rotated by the engine 2, and the ring gear R is held stationary by the brake B1. Therefore, the sun gear S and the first motor MG1 are rotated, and electric power is generated by the first motor MG1 and supplied to the battery. When the power generation by the first motor MG1 becomes unnecessary, the engine 2 is stopped again.

### [Overall Configuration of Hybrid Drive Device]

Next, the overall configuration of the hybrid drive device 1 according to the first embodiment will be described with reference to FIG. 2. In the description of the overall configuration of the hybrid drive device 1 with reference to FIG. 2, the description of the configurations of the disconnection clutch C1 and the brake B1 will be omitted, and will be given later together with the description with reference to FIG. 3.

As shown in FIG. 2, the hybrid drive device 1 includes a case 10 composed of a main case 10B, a housing case 10A, and a cover 10C. In the internal space of the case 10, the components are disposed on four axes: a first axis AX1 coaxial with the output shaft of the engine 2, a second axis AX2 different from and parallel to the first axis AX1, a third axis AX3 different from and parallel to the first axis AX1, and a fourth axis AX4 different from and parallel to the first axis AX1. The housing case 10A constituting the case 10 includes a first side wall 10Aa that covers the engine 2 side of the internal space. The main case 10B includes a center support 10Ba having a plate shape. The cover 10C includes a second side wall 10Ca that covers the opposite side of the internal space to the engine 2 side.

Hereinafter, a direction along the first axis AX1 will be referred to as “axial direction L.” One side in the axial direction L will be referred to as “first axial side LA” and the other side in the axial direction L will be referred to as “second axial side LB.” A direction orthogonal to the first axis AX1 will be referred to as “first radial direction R1.” In the present embodiment, the first axial side LA is the side in the axial direction L where the first motor MG1 is disposed relative to the planetary gear mechanism PR.

The input shaft 21 drivingly connected to the output shaft (not shown) of the engine 2 via a damper device (not shown), the planetary gear mechanism PR, the first motor MG1, a rotor shaft 22, etc. are disposed on the first axis AX1. The first motor MG1 includes a stator 3S stationarily supported on the main case 10B, and a rotor 3R that rotates on the inner circumferential side of the stator 3S (inward of the stator 3S in the first radial direction R1). The rotor 3R is firmly fixed to the rotor shaft 22.

The planetary gear mechanism PR includes the sun gear S, the ring gear R, and the carrier CR that rotatably supports the pinion gears P that mesh with the sun gear S and the ring gear R. The carrier CR is drivingly connected to the input shaft 21, that is, to the engine 2. The sun gear S is drivingly connected to the rotor shaft 22, that is, to the first motor MG1. The ring gear R is disposed on the inner circumferential side of a dog clutch mechanism 60 including the disconnection clutch C1 and the brake B1 described in detail later (inward of the dog clutch mechanism 60 in the first radial direction R1). A clutch gear GC of the disconnection clutch C1 described in detail later (see FIG. 3) is stationarily supported on an engine counter member 24 serving as an output transmission member. The engine counter member 24 is disposed on the first axis AX1, and a fourth gear G4 serving as a first drive gear is formed on the outer circumferential side (radially outer side) of the engine counter member 24. The engine counter member 24, that is, the fourth gear G4, is a gear that meshes with a driven gear disposed on an axis different from the first axis AX1. In the present embodiment, the driven gear is a second gear G2 that is disposed on the fourth axis AX4 and rotates together with the counter shaft 41 serving as the output member described later. The fourth gear G4 meshes with the second gear G2, and the engine counter member 24 is drivingly connected to the counter shaft 41 to serves as the output transmission member that transmits the rotation output by the planetary gear mechanism PR to the counter shaft 41.

The second motor MG2 and a rotor shaft 30 are disposed on the second axis AX2. The second motor MG2 includes a stator 4S stationarily supported on the main case 10B, and a rotor 4R that rotates on the inner circumferential side of the stator 4S (inward of the stator 4S in a direction orthogonal to the second axis AX2). The rotor shaft 30 rotates together with the rotor 4R. The rotor shaft 30 includes a first gear G1 serving as a second drive gear. In the present embodiment, the rotor shaft 30 includes a first shaft portion 31 and a second shaft portion 32. The first shaft portion 31 is connected to the rotor 4R to protrude on both sides in the axial direction L from the rotor 4R. The second shaft portion 32 is connected to the first shaft portion 31 to extend from the first shaft portion 31 to the second axial side LB. The first gear G1 is integrally formed on the outer circumference of the second shaft portion 32.

A differential gear mechanism 50 is disposed on the third axis AX3. The differential gear mechanism 50 includes a differential case 51 including left and right cylindrical portions 51L, 51R, and a fifth gear G5 fixed to the outer circumferential side of the differential case 51. A differential gear set 52 is housed inside the differential case 51, and is drivingly connected to left and right drive shafts (not shown) and to left and right wheels.

A counter unit 40 is disposed on the fourth axis AX4. The counter unit 40 includes the counter shaft 41, the second gear G2 drivingly connected to the outer circumference of the counter shaft 41, and a third gear G3 integrally formed on the outer circumference of the counter shaft 41. The second gear G2 meshes with the fourth gear G4 and also with the first gear G1. The second gear G2 has a larger diameter than the first gear G1 and has a function of reducing the speed of rotation of the second motor MG2. The second gear G2 has a larger diameter than the third gear G3. The third gear G3 is disposed at a different position in the axial direction L on the counter shaft 41 from that of the second gear G2, namely on the engine 2 side relative to the second gear G2.

In the present embodiment, the engine counter member 24 serving as the output transmission member includes an engaged portion P1 of a parking lock mechanism PL in addition to the fourth gear G4 serving as the first drive gear.

The engaged portion P1 is formed at a position adjacent to the fourth gear G4 in the axial direction L on the engine counter member 24. The engaged portion Pl is configured to be engaged with an engaging portion P2 of the parking lock mechanism PL.

In the present embodiment, the engaged portion P1 is a parking gear formed on the outer circumferential surface of the engine counter member 24. The engaging portion P2 is a parking pawl that turns about an axis along the axial direction L and selectively engages with the engaged portion P1 serving as the parking gear.

In the present embodiment, in a first radial view along the first radial direction R1, both the fourth gear G4 and the engaged portion P1 overlap a first ball bearing B3 serving as a first bearing.

### [Details of Dog Clutch Mechanism]

Next, the detailed configuration of the dog clutch mechanism 60 according to the first embodiment and its periphery, namely the planetary gear mechanism PR, the disconnection clutch C1, and the brake B1, will be described with reference to FIG. 3. FIG. 3 is an enlarged sectional view showing the planetary gear mechanism, the clutch, and the brake of the hybrid drive device according to the first embodiment.

As shown in FIG. 3, in the internal space surrounded by the main case 10B and the housing case 10A described above, a connecting shaft 23, a ring gear support member 25, the engine counter member 24, the planetary gear mechanism PR, and the dog clutch mechanism 60 are disposed on the outer circumference of the input shaft 21 and between the center support 10Ba and the first side wall 10Aa in the axial direction L.

Specifically, one end of the input shaft 21 is rotatably supported on the first side wall 10Aa by a second ball bearing B7, and the other end is rotatably supported on the center support 10Ba by a third ball bearing B2 via the rotor shaft 22. The connecting shaft 23 that includes the sun gear S and is drivingly connected to the rotor shaft 22 is disposed on the outer circumference of the input shaft 21. A thrust bearing B6 is disposed between the connecting shaft 23 and the input shaft 21 to rotatably support the connecting shaft 23 and to regulate the position in the axial direction L. The ring gear support member 25 having a substantially hollow disc shape and having the ring gear R fixed to its outer circumferential end is disposed on the outer circumference of the connecting shaft 23 and arranged side by side with the planetary gear mechanism PR in the axial direction L. The ring gear support member 25 is rotatably supported by thrust bearings B4, B5 between the connecting shaft 23 and the center support 10Ba, and its position in the axial direction L is regulated. The engine counter member 24 is rotatably disposed on the outer circumference of the center support 10Ba via the first ball bearing B3 serving as the first bearing.

The pinion gears P of the planetary gear mechanism PR and the carrier CR that rotatably supports the pinion gears P are disposed on the outer circumference of the sun gear S formed on the connecting shaft 23. One of the side plates of the carrier CR that is on the engine 2 side in the axial direction L (second axial side LB) is fixed to the input shaft 21. That is, the input shaft 21 and the carrier CR are drivingly connected. The ring gear R is disposed on the outer circumference of the pinion gears P. The dog clutch mechanism 60 is disposed on the outer circumference of the ring gear R.

Specifically, the dog clutch mechanism 60 includes a sleeve 61 disposed on the first axis AX1 to be movable in the axial direction L, a brake gear GB as second external teeth, and the clutch gear GC as third external teeth. That is, the brake B1 and the disconnection clutch C1 are structured as a so-called intermesh dog clutch. The brake gear GB of the brake B1 is fixed to the first side wall 10Aa of the housing case 10A. The clutch gear GC of the disconnection clutch C1 is fixed to the engine counter member 24. In other words, the brake gear GB is disposed on the opposite side in the axial direction L (second axial side LB) to the clutch gear GC via the planetary gear mechanism PR. The clutch gear GC is disposed on the inner circumferential side of the fourth gear G4 of the engine counter member 24 (inward of the fourth gear G4 in the first radial direction R1) to overlap the fourth gear G4 in the first radial view along the first radial direction R1. Thus, the fourth gear G4 and the clutch gear GC are not arranged in the axial direction L, and the length in the axial direction L is reduced. Regarding the disposition of two elements, the phrase “overlap when viewed in a specific direction” means that, when a virtual straight line parallel to the line-of-sight direction is moved in directions orthogonal to the virtual straight line, an area where the virtual straight line intersects both the two elements is present at least in part.

The sleeve 61 has internal teeth GS formed on its inner circumferential surface, and is movable in the axial direction L with the internal teeth GS meshing with external teeth GR serving as first external teeth and formed on the outer circumferential surface of the ring gear R. That is, the sleeve 61 is disposed on the outer circumference of the ring gear R of the planetary gear mechanism PR to overlap the ring gear R in the first radial view along the first radial direction R1. Thus, the sleeve 61 and the ring gear R are not arranged in the axial direction L, and the length in the axial direction L is reduced.

Two flange portions 61F each having a flange shape are formed on the outer circumferential side of the sleeve 61. The flange portions 61F are pushed (or pulled) by driving a shift fork (not shown), thereby moving the position in the axial direction L. The movement of the shift fork (not shown) is controlled by driving a drive motor (not shown) etc. in response to a command from the control unit (ECU). That is, the position of the sleeve 61 is controlled to switch by the control unit (ECU).

When the sleeve 61 is moved in the state shown in FIG. 3 toward the brake gear GB in the axial direction L and located in a brake lock position, the internal teeth GS mesh across the external teeth GR and the brake gear GB. That is, the ring gear R and the case 10 are drivingly connected. That is, the brake B1 is locked (engaged) to stop the rotation of the ring gear R (hold the ring gear R stationary). Therefore, for example, in the series mode described above, the ring gear R does not idle, and the rotation of the engine 2 is transmitted from the carrier CR to the first motor MG1 via the sun gear S. Thus, it is possible to perform charging using the first motor MG1 with the driving force of the engine 2. In this state, the internal teeth GS of the sleeve 61 are spaced away from the clutch gear GC, and the clutch C1 is in a released state.

When the sleeve 61 is moved in the state shown in FIG. 3 toward the clutch gear GC in the axial direction L (first axial side LA) and located in a clutch engagement position, the internal teeth GS mesh across the external teeth GR and the clutch gear GC. That is, the ring gear R and the engine counter member 24 are drivingly connected, and the ring gear R and the counter shaft 41 are drivingly connected via the fourth gear G4 and the second gear G2 (see FIG. 2). Therefore, the driving force of the engine 2 can be transmitted from the ring gear R to the wheels 90 via the counter shaft 41, for example, in the split mode described above. In this state, the internal teeth GS of the sleeve 61 are spaced away from the brake gear GB, and the brake B1 is in a released state.

As described above, the brake B1 serving as the brake unit is the intermesh brake structured using the sleeve 61, the external teeth GR serving as the first external teeth, and the brake gear GB serving as the second external teeth. The disconnection clutch C1 serving as the clutch unit is the intermesh clutch structured using the sleeve 61, the external teeth GR serving as the first external teeth, and the clutch gear GC serving as the third external teeth.

The dog clutch mechanism 60 structured as described above includes the sleeve 61, the brake gear GB, and the clutch gear GC. That is, the sleeve 61 is a single member. However, the sleeve 61 may be divided into a sleeve portion serving as the disconnection clutch C1 and a sleeve portion serving as the brake B1. Even in such consideration, the sleeve portion of the dog clutch mechanism 60 that constitutes the disconnection clutch C1 is disposed on the outer circumference of the planetary gear mechanism PR, and the sleeve portion of the dog clutch mechanism 60 that constitutes the brake B1 is also disposed on the outer circumference of the planetary gear mechanism PR. Therefore, it can be said that the disconnection clutch C1 is disposed to overlap the planetary gear mechanism PR in the first radial view along the first radial direction R1. Similarly, it can be said that the brake B1 is disposed to overlap the planetary gear mechanism PR in the first radial view along the first radial direction R1.

### [Intermediate Position of Sleeve During Mode Switching]

As described above, the brake B1 is engaged and the disconnection clutch C1 is released when the sleeve 61 is moved in the state shown in FIG. 3 toward the brake gear GB, and the disconnection clutch C1 is engaged and the brake B1 is released when the sleeve 61 is moved in the state shown in FIG. 3 toward the clutch gear GC. When the sleeve 61 is located between the brake gear GB and the clutch gear GC as in the state shown in FIG. 3, that is, when the sleeve 61 is in the intermediate position, the brake B1 and the disconnection clutch C1 are released. The intermediate position is a position where both the disconnection clutch Cl and the brake B1 are released, and therefore can be called a disconnection position.

That is, for example, when transition is made from the series mode to the split mode, the sleeve 61 is moved from the position where the brake B1 is engaged to the position where the disconnection clutch C1 is engaged. Conversely, for example, when transition is made from the split mode to the series mode, the sleeve 61 is moved from the position where the brake B1 is engaged to the position where the disconnection clutch C1 is engaged. At this time, the sleeve 61 always passes through the intermediate position (disconnection position).

Therefore, for example, when transition is made to the split mode while the engine 2 is being driven in the series mode and electric power is being generated by the first motor MG1 (charging is being performed), the counter shaft 41 rotates at a rotation speed corresponding to the vehicle speed. Thus, the rotation speed of the ring gear R needs to be matched to the rotation speed of the counter shaft 41, and the rotation speed of the engine 2 and the rotation speed of the first motor MG1 need to be adjusted to and synchronized with the rotation speed of the ring gear R. At this time, the sleeve 61 passes through the intermediate position (disconnection position) as described above. Even when the rotation speeds of the engine 2 and the first motor MG1 are changed in this state for synchronization, shocks due to inertia fluctuations etc. can be prevented because the sleeve 61 is disconnected from the counter shaft 41 and the case 10. Conversely, for example, when transition is made from the split mode to the series mode, the rotation speeds of the engine 2 and the first motor MG1 can be changed (synchronized) in the intermediate position (disconnection position) of this sleeve 61. Thus, shocks due to inertia fluctuations etc. can be prevented.

### [Engine Start and Stop in Series Mode]

For example, when EV traveling is performed using the driving force of the second motor MG2 in the split mode described above, the ring gear R rotates via the disconnection clutch C1. Since the engine 2 is stopped, the carrier CR of the planetary gear mechanism PR is stopped. Therefore, the sun gear S idles in the reverse rotation direction and the first motor MG1 idles in the reverse rotation direction. When the engine 2 is started in this state, the first motor MG1 needs to be driven to rotate in the forward rotation direction such that no change occurs in the rotation of the ring gear R and the first motor MG1 increases the rotation speed of the engine 2. In this case, the inertia component that increases the rotation speed of the engine 2 is initially output by the first motor MG1. When the engine 2 is started to output a driving force, it is required to control the first motor MG1 to regenerate such that no torque fluctuations occur in the ring gear R (wheels 90). Such complicated control needs to respond to disturbances such as fluctuations in traveling resistance and changes in accelerator operation amount made by the driver. Therefore, it is difficult to perform control to ensure that shocks due to torque fluctuations do not occur.

In the present embodiment, EV traveling is performed in the series mode. In particular, control is performed to start the engine 2 in the series mode. Even when torque fluctuations related to the starting of the engine 2 as described above are transmitted to the ring gear R in the series mode, there is no risk that the torque fluctuations are transmitted to the wheels 90 because the ring gear R is fixed by the brake B1 and the disconnection clutch C1 is released. That is, shocks due to the torque fluctuations related to the starting of the engine 2 are unlikely to occur regardless of the traveling condition. When the engine 2 is started, the ring gear R is held stationary by the brake B1. Therefore, the first motor MG1 is rotated as a starter to rotate the sun gear S while receiving a reaction force at the ring gear R, thereby increasing the rotation speed of the engine 2 via the carrier CR. That is, the engine 2 can be started by simply controlling the rotation of the first motor MG1.

### [Axial Positions of Disconnection Clutch and Brake]

In the present embodiment, in particular, the planetary gear mechanism PR is the single-pinion planetary gear mechanism. Therefore, the rotation speed of the ring gear R tends to increase relative to the rotation speed of the engine 2 in the split mode. Thus, the fourth gear G4 of the engine counter member 24 that receives the rotation of the ring gear R transmitted via the disconnection clutch C1 and transmits the rotation to the counter shaft 41 needs to have a larger diameter to increase the reduction ratio. Therefore, the fourth gear G4 has an outside diameter larger than the outside diameter of the planetary gear mechanism PR.

As shown in FIG. 2, in the dog clutch mechanism 60 of the hybrid drive device 1 of the present embodiment, the brake B1 is disposed on the engine 2 side in the axial direction L, that is, on the first side wall 10Aa side of the housing case 10A (second axial side LB), and the disconnection clutch C1 is disposed on the first motor MG1 side that is the opposite side in the axial direction L across the center of the planetary gear mechanism PR, that is, on the center support 10Ba side of the main case 10B (first axial side LA).

When assembling (manufacturing) the hybrid drive device 1 of the present embodiment, the first motor MG1 and the rotor shaft 22 are attached to the main case 10B, then the counter shaft 41 is attached to the center support 10Ba, and the engine counter member 24 (and the clutch gear GC) is attached while meshing the second gear G2 with the fourth gear G4. Since the carrier CR needs to be firmly fixed to the input shaft 21, the planetary gear mechanism PR (including the connecting shaft 23 (see FIG. 3)) is attached to the outer circumference of the input shaft 21. Then, the sleeve 61 is attached to the outer circumference of the planetary gear mechanism PR, the input shaft 21 is inserted into the rotor shaft 22 that has already been attached to the main case 10B, and the rotor shaft 22 and the connecting shaft 23 are attached by spline fitting. Then, the housing case 10A to which the brake gear GB is attached is attached to the main case 10B, and the hybrid drive device 1 is completed.

For example, it is assumed that, contrary to the present embodiment, the disconnection clutch C1 is disposed on the engine 2 side in the axial direction L (second axial side LB) and the brake B is disposed on the first motor MG1 side (first axial side LA). In this case, the engine counter member 24 having a larger diameter than the planetary gear mechanism PR is disposed on the engine 2 side relative to the planetary gear mechanism PR. In this case, with the engine counter member 24 attached integrally with the planetary gear mechanism PR while covering the outer circumference of the planetary gear mechanism PR, the connecting shaft 23 (see FIG. 3) is spline-fitted to the rotor shaft 22 and the counter shaft 41 that have already been attached to the main case 10B, and the fourth gear G4 is meshed with the second gear G2 at the same time. The assembling is extremely difficult. Considering mass production, in particular, the assembling is substantially impossible.

In the hybrid drive device 1 of the present embodiment, the brake B1 is disposed on the engine 2 side (second axial side LB) relative to the planetary gear mechanism PR in the axial direction L, and the disconnection clutch C1 is disposed on the first motor MG1 side (first axial side LA) relative to the planetary gear mechanism PR in the axial direction L. Therefore, the engine counter member 24 can be disposed on the first motor MG1 side relative to the planetary gear mechanism PR. Thus, the hybrid drive device 1 can be manufactured.

As described above, in the present embodiment, the engine counter member 24 serving as the output transmission member is rotatably supported by the first ball bearing B3 serving as the first bearing. As shown in FIG. 3, in the present embodiment, both the first ball bearing B3 serving as the first bearing and the disconnection clutch C1 serving as the clutch unit overlap the fourth gear G4 serving as the first drive gear in the first radial view along the first radial direction R1. In the example shown in FIG. 3, the first ball bearing B3 and the sleeve 61, the clutch gear GC, and the external teeth GR of the disconnection clutch Cl are disposed inward of the fourth gear G4 in the first radial direction R1. In the first radial view along the first radial direction R1, part of the first ball bearing B3, part of the movable range of the sleeve 61, the entire clutch gear GC, and part of the external teeth GR overlap the fourth gear G4.

In the present embodiment, the first ball bearing B3 serving as the first bearing is disposed between the first motor MG1 serving as the first rotary electric machine and the planetary gear mechanism PR in the axial direction L. With the first ball bearing B3 disposed between the first motor MG1 and the planetary gear mechanism PR in the axial direction L, the first ball bearing B3 may overlap at least one of the first motor MG1 and the planetary gear mechanism PR in the first radial view along the first radial direction R1.

As shown in FIG. 2, in the present embodiment, the rotor shaft 30 is rotatably supported by a fourth ball bearing B8 serving as a second bearing, a fifth ball bearing B9 serving as a third bearing, and a sixth ball bearing B10 serving as a fourth bearing.

The fourth ball bearing B8, the fifth ball bearing B9, and the sixth ball bearing B10 are bearings that support the rotor 4R of the second motor MG2 serving as the second rotary electric machine. As described above, the rotor shaft 30 is connected to the rotor 4R to rotate together. Therefore, the fourth ball bearing B8, the fifth ball bearing B9, and the sixth ball bearing B10 indirectly support the rotor 4R.

The fourth ball bearing B8 includes a fourth inner race B81, a fourth outer race B82 disposed outward of the fourth inner race B81 in a direction orthogonal to the second axis AX2, and fourth balls B83 that roll between the fourth inner race B81 and the fourth outer race B82.

The fifth ball bearing B9 includes a fifth inner race B91, a fifth outer race B92 disposed outward of the fifth inner race B91 in a direction orthogonal to the second axis AX2, and fifth balls B93 that roll between the fifth inner race B91 and the fifth outer race B92. The fifth ball bearing B9 is disposed on the opposite side in the axial direction L (first axial side LA) to the fourth ball bearing B8 across the rotor 4R. In the present embodiment, the fourth ball bearing B8 supports the end of the first shaft portion 31 of the rotor shaft 30 on the second axial side LB. The fifth ball bearing B9 supports the end of the first shaft portion 31 of the rotor shaft 30 on the first axial side LA.

The sixth ball bearing B10 includes a sixth inner race B101, a sixth outer race B102 disposed outward of the sixth inner race B101 in a direction orthogonal to the second axis AX2, and sixth balls B103 that roll between the sixth inner race B101 and the sixth outer race B102. The sixth ball bearing B10 is disposed on the opposite side in the axial direction L (second axial side LB) to the fourth ball bearing B8 across the first gear G1. In the present embodiment, the sixth ball bearing B10 supports the end of the second shaft portion 32 of the rotor shaft 30 on the second axial side LB.

In the present embodiment, a disposition area in the axial direction L for the first ball bearing B3 serving as the first bearing overlaps a disposition area in the axial direction L for the fourth ball bearing B8 serving as the second bearing. The “disposition area in the axial direction L” for a particular element refers to the entire area in the axial direction L where the element is disposed.

In the present embodiment, the first gear G1 serving as the second drive gear is disposed closer to the fourth ball bearing B8 serving as the second bearing in the area between the fourth ball bearing B8 and the sixth ball bearing B10 serving as the fourth bearing in the axial direction L.

In the present embodiment, the case 10 includes a first bearing support portion 11, a second bearing support portion 12, and a third bearing support portion 13.

The first bearing support portion 11 supports the fourth ball bearing B8 serving as the second bearing. In the present embodiment, the first bearing support portion 11 has a tubular shape that protrudes from the center support 10Ba of the main case 10B to the second axial side LB. The first bearing support portion 11 supports the fourth outer race B82 of the fourth ball bearing B8 from the outside in the direction orthogonal to the second axis AX2, and also supports the fourth outer race B82 from the first axial side LA.

The second bearing support portion 12 supports the fifth ball bearing B9 serving as the third bearing. In the present embodiment, the second bearing support portion 12 has a tubular shape that protrudes from the second side wall 10Ca of the cover 10C to the second axial side LB. The second bearing support portion 12 supports the fifth outer race B92 of the fifth ball bearing B9 from the outside in the direction orthogonal to the second axis AX2, and also supports the fifth outer race B92 from the first axial side LA.

The third bearing support portion 13 supports the sixth ball bearing B10 serving as the fourth bearing. In the present embodiment, the third bearing support portion 13 has a tubular shape that protrudes from the first side wall 10Aa of the housing case 10A to the first axial side LA. The third bearing support portion 13 supports the sixth outer race B102 of the sixth ball bearing B10 from the outside in the direction orthogonal to the second axis AX2, and also supports the sixth outer race B102 from the second axial side LB.

In the present embodiment, the rotor shaft 30 includes a first step surface 30a oriented to the second axial side LB, a second step surface 30b oriented to the first axial side LA, and a third step surface 30c oriented to the second axial side LB.

The first step surface 30a is formed on the first shaft portion 31 of the rotor shaft 30. The first step surface 30a is disposed to face the fourth inner race B81 of the fourth ball bearing B8 from the first axial side LA.

The second step surface 30b is formed on the first shaft portion 31 of the rotor shaft 30. The second step surface 30b is disposed to face the fifth inner race B91 of the fifth ball bearing B9 from the second axial side LB.

The third step surface 30c is formed on the second shaft portion 32 of the rotor shaft 30. The third step surface 30c is disposed to face the sixth inner race B101 of the sixth ball bearing B10 from the first axial side LA.

In the present embodiment, a washer W is disposed between the first gear G1 and the fourth ball bearing B8 in the axial direction L. The washer W is disposed in contact with the first gear G1 from the first axial side LA and with the fourth inner race B81 of the fourth ball bearing B8 from the second axial side LB. The fourth outer race B82 of the fourth ball bearing B8 is disposed in contact with the first bearing support portion 11 of the case 10 from the second axial side LB.

In the present embodiment, the fifth inner race B91 of the fifth ball bearing B9 is disposed in contact with the second step surface 30b of the rotor shaft 30 from the first axial side LA. The fifth outer race B92 of the fifth ball bearing B9 is disposed in contact with the second bearing support portion 12 of the case 10 from the second axial side LB.

In the present embodiment, the first gear G1, the second gear G2, the third gear G3, the fourth gear G4, and the fifth gear G5 are helical gears. Therefore, in the present embodiment, when these gears are transmitting torque during traveling of the vehicle etc., loads in the axial direction L (thrust load) act on the gears.

The load acting on the first gear G1 in the axial direction L is transmitted to the first bearing support portion 11 via the fourth ball bearing B8. In the present embodiment, the load acting on the first gear G1 in the axial direction L is transmitted to the first bearing support portion 11 through the washer W and the fourth ball bearing B8 in the stated order.

The load acting on the first gear G1 in the axial direction L may also be transmitted to the second bearing support portion 12 via the rotor shaft 30 and the fifth ball bearing B9. Specifically, the load acting on the first gear G1 in the axial direction L may be transmitted to the second bearing support portion 12 through the washer W, the first shaft portion 31, and the fifth ball bearing B9 in the stated order, and may be transmitted to the second bearing support portion 12 through the washer W, the fourth ball bearing B8, the first shaft portion 31, and the fifth ball bearing B9 in the stated order.

In the present embodiment, the end of the first shaft portion 31 of the rotor shaft 30 on the second axial side LB is slightly spaced away from the washer W in the axial direction L and the first step surface 30a of the rotor shaft 30 is slightly spaced away from the fourth inner race B81 of the fourth ball bearing B8 in the axial direction L with the first gear G1 and the washer W in contact with each other in the axial direction L and the fourth inner race B81 and the washer W in contact with each other in the axial direction L.

That is, the clearance in the axial direction L in the transmission path of the load that is transmitted in the axial direction L from the first gear G1 serving as the second drive gear to the first bearing support portion 11 via the fourth ball bearing B8 serving as the second bearing is narrower than the clearance in the axial direction L in the transmission path of the load that is transmitted in the axial direction L from the first gear G1 serving as the second drive gear to the second bearing support portion 12 via the rotor shaft 30 and the fifth ball bearing B9 serving as the third bearing.

In the present embodiment, as described above, the first gear G1 and the washer W are in contact with each other in the axial direction L, and the fourth inner race B81 and the washer W are in contact with each other in the axial direction L. Therefore, most of the load acting on the first gear G1 in the axial direction L is transmitted to the first bearing support portion 11 via the washer W and the fourth ball bearing B8. In this state, the end of the first shaft portion 31 on the second axial side LB is slightly spaced away from the washer W in the axial direction L, and the first step surface 30a is slightly spaced away from the fourth inner race B81 in the axial direction L. Therefore, the load acting on the first gear G1 in the axial direction L is unlikely to be transmitted to the second bearing support portion 12 through the washer W, the fourth ball bearing B8, the first shaft portion 31, and the fifth ball bearing B9. In this way, the load acting on the first gear G1 in the axial direction L is less likely to be transmitted to the second bearing support portion 12 than to the first bearing support portion 11.

### [Summary of First Embodiment]

As described above, in the hybrid drive device 1 according to the first embodiment, the disconnection clutch C1 is disposed coaxially with the first motor MG1 to overlap the power distribution planetary gear mechanism PR in the first radial view along the first radial direction R1. Therefore, an increase in size in the axial direction L can be suppressed compared to, for example, a case where the disconnection clutch Cl is disposed coaxially with the second motor MG2 that is larger in size than the first motor MG1.

The disconnection clutch C1 and the brake B1 are structured by the dog clutch mechanism 60, and the sleeve 61 of the dog clutch mechanism 60 is disposed on the outer circumferential side (outward of the ring gear R of the power distribution planetary gear mechanism PR in the first radial direction R1) to overlap the ring gear R in the first radial view along the first radial direction R1. Therefore, the sleeve 61 and the ring gear R are not arranged in the axial direction L, and an increase in size in the axial direction L can be suppressed.

The clutch gear GC is disposed on the inner circumferential side of the fourth gear G4 (inward of the fourth gear G4 in the first radial direction R1) to overlap the fourth gear G4 in the first radial view along the first radial direction R1. Therefore, the fourth gear G4 and the clutch gear GC are not arranged in the axial direction L, and an increase in size in the axial direction L can be suppressed.

### Second Embodiment

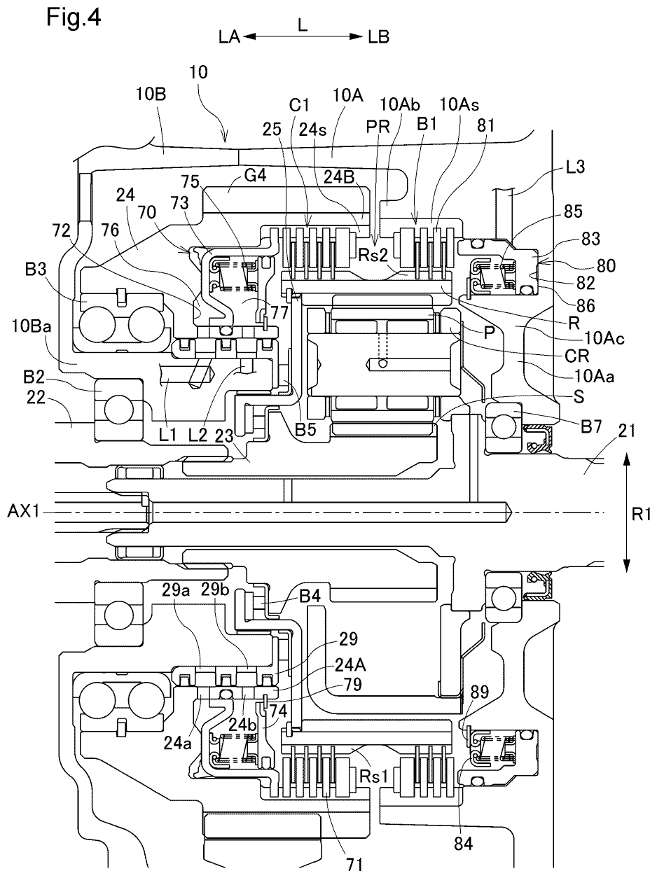

Next, a second embodiment that is a partial modification of the first embodiment will be described with reference to FIG. 4. FIG. 4 is an enlarged sectional view showing a planetary gear mechanism, a clutch, and a brake of a hybrid drive device according to the second embodiment. In the description of the second embodiment, the same parts as those of the first embodiment are denoted by the same reference signs, and description thereof will be omitted.

In the hybrid drive device 1 according to the first embodiment, the disconnection clutch C1 and the brake B1 are structured as the so-called dog clutches. In the hybrid drive device 1 according to the second embodiment, the disconnection clutch C1 and the brake B1 are structured as wet-type multi-disc friction engagement elements (multi-disc clutch or multi-disc brake).

Specifically, as shown in FIG. 4, in the hybrid drive device 1 of the second embodiment, a tip portion 24B of the engine counter member 24 that includes the fourth gear G4 is formed to cover substantial half of the first motor MG1 side in the axial direction L (first axial side LA) on the outer circumferential side of the planetary gear mechanism PR (outward of the planetary gear mechanism PR in the first radial direction R1). A plurality of friction plates 71 (inner friction plates and outer friction plates) of the disconnection clutch C1 is disposed by spline engagement between a spline 24s formed on the inner circumferential surface of the tip portion 24B of the engine counter member 24 and a spline Rs1 formed on the outer circumferential surface of the ring gear R of the planetary gear mechanism PR. A hydraulic servo 70 that can hydraulically push the friction plates 71 is disposed while being enclosed within the engine counter member 24 between the tip portion 24B of the engine counter member 24 and a cylindrical portion 24A formed to extend cylindrically in the axial direction L on the inner circumferential side (inward of the tip portion 24B in the first radial direction R1).

The hydraulic servo 70 roughly includes a cylinder portion 72 formed by a circumferential surface surrounded by the engine counter member 24, a piston member 73, a plate member 74, and a return spring 75. A hydraulic oil chamber 76 is formed between the cylinder portion 72 and the piston member 73. A cancellation oil chamber 77 is formed between the piston member 73 and the plate member 74. The plate member 74 is positioned and supported by a snap ring 79 relative to the cylindrical portion 24A of the engine counter member 24, and receives an urging force of the return spring 75. The return spring 75 urges the piston member 73 toward the cylinder portion 72 by its urging force. A sleeve member 29 having a sleeve shape is disposed between the engine counter member 24 and the center support 10Ba.

The center support 10Ba has an oil passage L1 to be supplied with an engagement pressure for the disconnection clutch C1 that is generated by a hydraulic control device (not shown). The oil passage L1 communicates with the hydraulic oil chamber 76 via an oil hole 29a formed in the sleeve member 29 in the first radial direction R1 and an oil hole 24a formed in the cylindrical portion 24A of the engine counter member 24 in the first radial direction R1. The center support 10Ba also has an oil passage L2 to be supplied with a lubricating pressure generated by the hydraulic control device (not shown). Similarly, the oil passage L2 communicates with the cancellation oil chamber 77 via an oil hole 29b formed in the sleeve member 29 in the first radial direction R1 and an oil hole 24b formed in the cylindrical portion 24A of the engine counter member 24 in the first radial direction R1.

The disconnection clutch C1 including the hydraulic servo 70 and the friction plates 71 structured in this way is engaged by pushing the friction plates 71 using the piston member 73 against the urging force of the return spring 75 when the engagement pressure is supplied to the hydraulic oil chamber 76 from the hydraulic control device (not shown). When the engagement pressure is discharged from the hydraulic oil chamber 76, the piston member 73 moves away from the friction plates 71 by the urging force of the return spring 75, thereby releasing the disconnection clutch C1. Since the cancellation oil chamber 77 stores lubricating oil supplied from the oil passage L2, it generates a centrifugal oil pressure that is substantially the same as that of the oil in the hydraulic oil chamber 76 during rotation, thereby canceling the centrifugal oil pressure in the hydraulic oil chamber 76 generated in the piston member 73.

The housing case 10A includes a drum portion 10Ab extending from the first side wall 10Aa in the axial direction L to cover substantial half of the engine 2 side in the axial direction L (second axial side LB) on the outer circumferential side of the planetary gear mechanism PR (outward of the planetary gear mechanism PR in the first radial direction R1). A plurality of friction plates 81 (inner friction plates and outer friction plates) of the brake B1 is disposed by spline engagement between a spline 10As formed on the inner circumferential surface of the drum portion 10Ab of the housing case 10A and a spline Rs2 formed on the outer circumferential surface of the ring gear R of the planetary gear mechanism PR. A hydraulic servo 80 that can hydraulically push the friction plates 81 is disposed while being enclosed within the housing case 10A between the drum portion 10Ab of the housing case 10A and a cylindrical portion 10Ac formed to extend cylindrically in the axial direction L on the inner circumferential side (inward of the drum portion 10Ab in the first radial direction R1).

The hydraulic servo 80 roughly includes a cylinder portion 82 formed by a circumferential surface surrounded by the housing case 10A, a piston member 83, a plate member 84, and a return spring 85. A hydraulic oil chamber 86 is formed between the cylinder portion 82 and the piston member 83. The plate member 84 is positioned and supported by a snap ring 89 relative to the cylindrical portion 10Ac of the housing case 10A, and receives an urging force of the return spring 85. The return spring 85 urges the piston member 83 toward the cylinder portion 82 by its urging force.

The housing case 10A has an oil passage L3 to be supplied with an engagement pressure for the brake B1 that is generated by the hydraulic control device (not shown). The oil passage L3 communicates with the hydraulic oil chamber 86.

The brake B1 including the hydraulic servo 80 and the friction plates 81 structured in this way is engaged by pushing the friction plates 81 using the piston member 83 against the urging force of the return spring 85 when the engagement pressure is supplied to the hydraulic oil chamber 86 from the hydraulic control device (not shown). When the engagement pressure is discharged from the hydraulic oil chamber 86, the piston member 83 moves away from the friction plates 81 by the urging force of the return spring 85, thereby releasing the brake B1. Since the hydraulic servo 80 of the brake B1 does not rotate, the centrifugal oil pressure is not generated and the cancellation oil chamber is not required.

### [Summary of Second Embodiment]

In the hybrid drive device 1 according to the second embodiment structured as described above, at least part of the disconnection clutch C1 (friction plates 71) is disposed coaxially with the first motor MG1 to overlap the outer circumference of the power distribution planetary gear mechanism PR in the first radial view along the first radial direction R1. Therefore, an increase in size in the axial direction L can be suppressed compared to, for example, a case where the disconnection clutch C1 is disposed coaxially with the second motor MG2 that is larger in size than the first motor MG1.

The disconnection clutch C1 and the brake B1 are structured as the multi-disc friction engagement elements that can be hydraulically controlled for engagement as in the second embodiment. Therefore, both the disconnection clutch C1 and the brake B1 can be released. Thus, with both the disconnection clutch C1 and the brake B1 released, synchronization control can be performed to synchronize the rotation speeds of the engine 2 and the first motor MG1 with the rotation speed corresponding to the vehicle speed during switching between the series mode and the split mode, thereby simplifying the synchronization control and reducing the occurrence of shocks.

The brake B1 is disposed on the engine 2 side (second axial side LB) relative to the planetary gear mechanism PR in the axial direction L, and the disconnection clutch C1 is disposed on the first motor MG1 side (first axial side LA) relative to the planetary gear mechanism PR in the axial direction L. Therefore, the engine counter member 24 can be disposed on the first motor MG1 side relative to the planetary gear mechanism PR. Thus, the hybrid drive device 1 can be manufactured.

Other structures, operations, and effects in the second embodiment are the same as those in the first embodiment, and therefore description thereof will be omitted.

### Possibilities of Other Embodiments

In the first and second embodiments described above, part of the brake B1 overlaps the planetary gear mechanism PR in the first radial view along the first radial direction R1. However, the brake B1 need not essentially overlap the planetary gear mechanism PR. However, the effect of reducing the length in the axial direction L is achieved when part of the brake B1 overlaps the planetary gear mechanism PR in the first radial view along the first radial direction R1.

In the first embodiment, the disconnection clutch C1 and the brake B1 are structured as the dog clutches (the dog clutch referred to herein is not limited to the one in which both rotary members rotate but also includes a brake in which one of the members is held stationary). In the second embodiment, the disconnection clutch C1 and the brake B1 are structured as the multi-disc friction engagement elements. For example, one may be a dog clutch and the other may be a multi-disc friction engagement element.

In the first and second embodiments, the second motor MG2 is drivingly connected directly to the counter shaft 41 (wheels 90). However, the present disclosure is not limited to this. A speed change mechanism that changes the speed of rotation of the second motor MG2 and transmits the rotation to the counter shaft 41 may be provided. In the first and second embodiments, the counter shaft 41 is drivingly connected directly to the wheels 90 via the differential gear mechanism 50. However, the present disclosure is not limited to this. A speed change mechanism that changes the speed of rotation of the counter shaft 41 and transmits the rotation to the differential gear mechanism 50 may be provided.

In the first and second embodiments, the hybrid drive device 1 is suitable for use in an FF type vehicle. However, the present disclosure is not limited to this. For example, the hybrid drive device 1 may be used in a vehicle of a type in which four-wheel drive can be performed by providing a rear motor for driving rear wheels.

In the above embodiments, the power distribution planetary gear mechanism PR is the single-pinion planetary gear mechanism. However, the present disclosure is not limited to this. Any type of planetary gear mechanism may be used, such as a double-pinion planetary gear mechanism or a step-pinion planetary gear mechanism.

### [Summary of Embodiments]

Hereinafter, a summary of the hybrid drive device (1) described above will be provided.

The hybrid drive device (1) includes:
a first rotary electric machine (MG1) disposed on a first axis (AX1);
an input member (21) disposed on the first axis (AX1) and drivingly connected to an engine (2);
a second rotary electric machine (MG2) disposed on a second axis (AX2) different from the first axis (AX1);
an output member (41) that is drivingly connected to the second rotary electric machine (MG2) and outputs rotation;
a power distribution planetary gear mechanism (PR) including a first rotary element drivingly connected to the first rotary electric machine (MG1), a second rotary element drivingly connected to the input member (21), and a third rotary element drivingly connected to the output member (41), the planetary gear mechanism (PR) being disposed on the first axis (AX1);
a brake unit (B1) that locks rotation of the third rotary element relative to a case (10); and
a clutch unit (C1) interposed between the third rotary element and the output member (41) and configured to disconnect the third rotary element and the output member (41), in which when a direction orthogonal to the first axis (AX1) is a first radial direction (R1),
the clutch unit (C1) is disposed on the first axis (AX1) and disposed on an outer circumferential side of the planetary gear mechanism (PR) to overlap the planetary gear mechanism (PR) in a first radial view along the first radial direction (R1).

With this configuration, it is possible to switch the split system and the series system while suppressing an increase in size of the hybrid drive device (1) in the axial direction (L).

It is preferable that the brake unit (B1) be disposed on the first axis (AX1) and disposed on the outer circumferential side of the planetary gear mechanism (PR) to overlap the planetary gear mechanism (PR) in the first radial view.

With this configuration, it is possible to suppress an increase in size of the hybrid drive device (1) in the axial direction (L).

It is preferable that the third rotary element be a ring gear (R) including first external teeth (GR) formed on an outer circumference,
the hybrid drive device (1) include:
a sleeve (61) disposed on the first axis (AX1) and movable in an axial direction (L) that is a direction along the first axis (AX1) while meshing with the first external teeth (GR) of the ring gear (R);
an output transmission member (24) disposed on the first axis (AX1) and drivingly connected to the output member (41);
second external teeth (GB) provided on the case (10); and
third external teeth (GC) provided on the output transmission member (24),
the brake unit (B1) be an intermesh brake structured using the sleeve (61), the first external teeth (GR), and the second external teeth (GB),
the clutch unit (C1) be an intermesh clutch structured using the sleeve (61), the first external teeth (GR), and the third external teeth (GC), and
the sleeve (61) be disposed on an outer circumferential side of the ring gear (R) to overlap the ring gear (R) in the first radial view.

In this configuration, the sleeve (61) is shared by the brake unit (B1) and the clutch unit (C1). The sleeve (61) overlaps the ring gear (R) in the first radial view. Thus, it is possible to suppress an increase in size of the hybrid drive device (1) in the axial direction (L).

In the above configuration, it is preferable that the output transmission member (24) include a first drive gear (G4) that meshes with a driven gear (G2) disposed on
an axis different from the first axis (AX1), and
the third external teeth (GC) be disposed on an inner circumferential side of the first drive gear (G4) to overlap the first drive gear (G4) in the first radial view.

With this configuration, it is possible to suppress an increase in size of the hybrid drive device (1) in the axial direction (L).

It is preferable that the hybrid drive device (1) include
an output transmission member (24) that is disposed on the first axis (AX1) while being rotatably supported by a first bearing (B3), and is drivingly connected to the output member (41),
the output transmission member (24) include a first drive gear (G4) that meshes with a driven gear (G2) disposed on an axis different from the first axis (AX1), and
both the first bearing (B3) and the clutch unit (C1) overlap the first drive gear (G4) in the first radial view.

In this configuration, both the first bearing (B3) and the clutch unit (C1) overlap the first drive gear (G4) in the first radial view. Therefore, it is easier to reduce the space in the axial direction (L) that is required for disposing the members on the first axis (AX1) than in a case where at least one of the first bearing (B3) and the clutch unit (C1) does not overlap the first drive gear (G4) in the first radial view. Thus, it is easy to reduce the dimension of the hybrid drive device (1) in the axial direction (L).

It is preferable that the hybrid drive device (1) include
an output transmission member (24) that is disposed on the first axis (AX1) while being rotatably supported by a first bearing (B3), and is drivingly connected to the output member (41),
the output transmission member (24) include a first drive gear (G4) that meshes with a driven gear (G2) disposed on an axis different from the first axis (AX1) and the second axis (AX2), when a direction along the first axis (AX1) is an axial direction (L),
the first bearing (B3) be disposed between the first rotary electric machine (MG1) and the planetary gear mechanism (PR) in the axial direction (L),
the first bearing (B3) overlap the first drive gear (G4) in the first radial view, and
a disposition area in the axial direction (L) for the first bearing (B3) overlap a disposition area in the axial direction (L) for a second bearing (B8) that supports a rotor (4R) of the second rotary electric machine (MG2).

In this configuration, the disposition area in the axial direction (L) for the first bearing (B3) overlaps the disposition area in the axial direction (L) for the second bearing (B8). Therefore, it is easier to reduce the space in the axial direction (L) that is required for disposing the members on the first axis (AX1) and the second axis (AX2) than in a case where the disposition areas do not overlap each other. Thus, it is easy to reduce the dimension of the hybrid drive device (1) in the axial direction (L).

It is preferable that the hybrid drive device (1) include:
a rotor shaft (30) that rotates together with the rotor (4R) of the second rotary electric machine (MG2); and
a second drive gear (G1) that rotates together with the rotor shaft (30) and meshes with the driven gear (G2),
the rotor shaft (30) be rotatably supported by the second bearing (B8), a third bearing (B9) disposed on an opposite side in the axial direction (L) to the second bearing (B8) across the rotor (4R) of the second rotary electric machine (MG2), and a fourth bearing (B10) disposed on an opposite side in the axial direction (L) to the second bearing (B8) across the second drive gear (G1), and
the second drive gear (G1) be disposed closer to the second bearing (B8) in an area between the second bearing (B8) and the fourth bearing (B10) in the axial direction (L).

With this configuration, it is possible to appropriately realize the configuration in which the driven gear (G2) is disposed to mesh with the first drive gear (G4) disposed between the first rotary electric machine (MG1) and the planetary gear mechanism (PR) in the axial direction (L) and the second drive gear (G1) meshes with the driven gear (G2).

It is preferable that the output transmission member (24) include an engaged portion (P1) of a parking lock mechanism (PL) in addition to the first drive gear (G4),
when a direction along the first axis (AX1) is an axial direction (L),
the engaged portion (P1) be formed at a position adjacent to the first drive gear (G4) in the axial direction (L) on the output transmission member (24), and configured to be engaged with an engaging portion (P2) of the parking lock mechanism (PL), and
both the first drive gear (G4) and the engaged portion (P1) overlap the first bearing (B3) in the first radial view.

In this configuration, even when the output transmission member (24) includes the engaged portion (P1) of the parking lock mechanism (PL) in addition to the first drive gear (G4) that meshes with the driven gear (G2), both the first drive gear (G4) and the engaged portion (P1) overlap the first bearing (B3). Therefore, it is possible to suppress expansion of the space in the axial direction (L) that is required for disposing the members on the first axis (AX1) due to the engaged portion (P1). Thus, it is easy to reduce the dimension of the hybrid drive device (1) in the axial direction (L).

It is preferable that the hybrid drive device (1) include:
a rotor shaft (30) that rotates together with a rotor (4R) of the second rotary electric machine (MG2); and
a second drive gear (G1) that rotates together with the rotor shaft (30) and meshes with a driven gear (G2) disposed on an axis different from the first axis (AX1),
when a direction along the first axis (AX1) is an axial direction (L),
the rotor shaft (30) be rotatably supported by a second bearing (B8), a third bearing (B9) disposed on an opposite side in the axial direction (L) to the second bearing (B8) across the rotor (4R) of the second rotary electric machine (MG2), and a fourth bearing (B10) disposed on an opposite side in the axial direction (L) to the second bearing (B8) across the second drive gear (G1),
the second bearing (B8) be supported by a first bearing support portion (11) provided on the case (10),
the third bearing (B9) be supported by a second bearing support portion (12) provided on the case (10), and
a clearance in the axial direction (L) in a transmission path of a load that is transmitted in the axial direction (L) from the second drive gear (G1) to the first bearing support portion (11) via the second bearing (B8) be narrower than a clearance in the axial direction (L) in a transmission path of a load that is transmitted in the axial direction (L) from the second drive gear (G1) to the second bearing support portion (12) via the rotor shaft (30) and the third bearing (B9).

With this configuration, most of the load acting on the second drive gear (G1) in the axial direction (L) as a result of meshing with the driven gear (G2) can be borne by the first bearing support portion (11) via the second bearing (B8). Thus, it is possible to reduce the load that is transmitted in the axial direction (L) to the second bearing support portion (12) that supports the third bearing (B9) disposed on the opposite side in the axial direction (L) to the second bearing (B8) across the rotor (4R). Since the second bearing support portion (12) supports the third bearing (B9) disposed on the opposite side in the axial direction (L) to the second bearing (B8) across the rotor (4R), the second bearing support portion (12) is often disposed at a position close to the end of the case (10) in the axial direction (L). As a result, when vibration is transmitted to the second bearing support portion (12), noise to the outside of the case (10) is likely to increase. In this configuration, however, it is possible to reduce the load that is transmitted in the axial direction (L) to the second bearing support portion (12) as described above. Thus, it is easier to reduce the noise to the outside of the case (10).

### Industrial Applicability

The technology according to the present disclosure can be used in a hybrid drive device mounted on a vehicle etc.

### DESCRIPTION OF THE REFERENCE NUMERALS

1 . . . hybrid drive device/2 . . . engine/10 . . . case/21 . . . input shaft (input member)/24 . . . engine counter member (output transmission member)/41 . . . counter shaft (output member)/61 . . . sleeve/AX1 . . . first axis/AX2 . . . second axis/MG1 . . . first motor (first rotary electric machine)/MG2 . . . second motor (second rotary electric machine)/PR . . . planetary gear mechanism/S . . . sun gear (first rotary element)/CR . . . carrier (second rotary element)/R . . . ring gear (third rotary element)/B1 . . . brake (brake unit, intermesh brake)/C1 . . . disconnection clutch (clutch unit, intermesh clutch)/GR . . . external teeth (first external teeth)/GB . . . brake gear (second external teeth)/GC . . . clutch gear (third external teeth)/G1 . . . first gear (second drive gear)/G2 . . . second gear (driven gear)/G4 . . . fourth gear (first drive gear)/B3 . . . first ball bearing (first bearing)/B8 . . . fourth ball bearing (second bearing)/B9 . . . fifth ball bearing (third bearing)/B10 . . . sixth ball bearing (fourth bearing)

1. A hybrid drive device comprising:
a first rotary electric machine disposed on a first axis;
an input member disposed on the first axis and drivingly connected to an engine;
a second rotary electric machine disposed on a second axis different from the first axis;
an output member that is drivingly connected to the second rotary electric machine and outputs rotation;
a power distribution planetary gear mechanism including a first rotary element drivingly connected to the first rotary electric machine, a second rotary element drivingly connected to the input member, and a third rotary element drivingly connected to the output member, the planetary gear mechanism being disposed on the first axis;
a brake unit that locks rotation of the third rotary element relative to a case; and
a clutch unit interposed between the third rotary element and the output member and configured to disconnect the third rotary element and the output member, wherein
when a direction orthogonal to the first axis is a first radial direction,
the clutch unit is disposed on the first axis and disposed on an outer circumferential side of the planetary gear mechanism to overlap the planetary gear mechanism in a first radial view along the first radial direction.

2. The hybrid drive device according to claim 1, wherein the brake unit is disposed on the first axis and disposed on the outer circumferential side of the planetary gear mechanism to overlap the planetary gear mechanism in the first radial view.

3. The hybrid drive device according to claim 1, wherein:
the third rotary element is a ring gear including first external teeth formed on an outer circumference;
the hybrid drive device includes:
a sleeve disposed on the first axis and movable in an axial direction that is a direction along the first axis while meshing with the first external teeth of the ring gear;
an output transmission member disposed on the first axis and drivingly connected to the output member;
second external teeth provided on the case; and
third external teeth provided on the output transmission member;
the brake unit is an intermesh brake structured using the sleeve, the first external teeth, and the second external teeth;
the clutch unit is an intermesh clutch structured using the sleeve, the first external teeth, and the third external teeth; and
the sleeve is disposed on an outer circumferential side of the ring gear to overlap the ring gear in the first radial view.

4. The hybrid drive device according to claim 3, wherein:
the output transmission member includes a first drive gear that meshes with a driven gear disposed on an axis different from the first axis; and
the third external teeth are disposed on an inner circumferential side of the first drive gear to overlap the first drive gear in the first radial view.

5. The hybrid drive device according to claim 1, further comprising an output transmission member that is disposed on the first axis while being rotatably supported by a first bearing, and is drivingly connected to the output member, wherein:
the output transmission member includes a first drive gear that meshes with a driven gear disposed on an axis different from the first axis; and
both the first bearing and the clutch unit overlap the first drive gear in the first radial view.

6. The hybrid drive device according to claim 1, further comprising an output transmission member that is disposed on the first axis while being rotatably supported by a first bearing, and is drivingly connected to the output member, wherein:
the output transmission member includes a first drive gear that meshes with a driven gear disposed on an axis different from the first axis and the second axis;
when a direction along the first axis is an axial direction,
the first bearing is disposed between the first rotary electric machine and the planetary gear mechanism in the axial direction;
the first bearing overlaps the first drive gear in the first radial view; and
a disposition area in the axial direction for the first bearing overlaps a disposition area in the axial direction for a second bearing that supports a rotor of the second rotary electric machine.

7. The hybrid drive device according to claim 6, further comprising:
a rotor shaft that rotates together with the rotor of the second rotary electric machine; and
a second drive gear that rotates together with the rotor shaft and meshes with the driven gear, wherein:
the rotor shaft is rotatably supported by the second bearing, a third bearing disposed on an opposite side in the axial direction to the second bearing across the rotor of the second rotary electric machine, and a fourth bearing disposed on an opposite side in the axial direction to the second bearing across the second drive gear; and
the second drive gear is disposed closer to the second bearing in an area between the second bearing and the fourth bearing in the axial direction.

8. The hybrid drive device according to claim 5, wherein:
the output transmission member includes an engaged portion of a parking lock mechanism in addition to the first drive gear;
when a direction along the first axis is an axial direction,
the engaged portion is formed at a position adjacent to the first drive gear in the axial direction on the output transmission member, and configured to be engaged with an engaging portion of the parking lock mechanism; and
both the first drive gear and the engaged portion overlap the first bearing in the first radial view.

9. The hybrid drive device according to claim 1, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

10. The hybrid drive device according to claim 6, wherein:
the output transmission member includes an engaged portion of a parking lock mechanism in addition to the first drive gear;
when a direction along the first axis is an axial direction,
the engaged portion is formed at a position adjacent to the first drive gear in the axial direction on the output transmission member, and configured to be engaged with an engaging portion of the parking lock mechanism; and
both the first drive gear and the engaged portion overlap the first bearing in the first radial view.

11. The hybrid drive device according to claim 7, wherein:
the output transmission member includes an engaged portion of a parking lock mechanism in addition to the first drive gear;
when a direction along the first axis is an axial direction,
the engaged portion is formed at a position adjacent to the first drive gear in the axial direction on the output transmission member, and configured to be engaged with an engaging portion of the parking lock mechanism; and
both the first drive gear and the engaged portion overlap the first bearing in the first radial view.

12. The hybrid drive device according to claim 2, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

13. The hybrid drive device according to claim 3, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

14. The hybrid drive device according to claim 4, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

15. The hybrid drive device according to claim 5, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

16. The hybrid drive device according to claim 6, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.

17. The hybrid drive device according to claim 7, further comprising:
a rotor shaft that rotates together with a rotor of the second rotary electric machine; and
a second drive gear that rotates together with the rotor shaft and meshes with a driven gear disposed on an axis different from the first axis, wherein:
when a direction along the first axis is an axial direction,
the rotor shaft is rotatably supported by a second bearing, a third bearing disposed on an opposite side in the axial direction to the second bearing across the rotor of the second rotary electric machine, and a fourth bearing disposed on an opposite side in the axial direction to the second bearing across the second drive gear;
the second bearing is supported by a first bearing support portion provided on the case;
the third bearing is supported by a second bearing support portion provided on the case; and
a clearance in the axial direction in a transmission path of a load that is transmitted in the axial direction from the second drive gear to the first bearing support portion via the second bearing is narrower than a clearance in the axial direction in a transmission path of a load that is transmitted in the axial direction from the second drive gear to the second bearing support portion via the rotor shaft and the third bearing.
